(19) United States
(12) Patent Application Publication
(10) Pub. No.: US 2008/0073157 A1
(43) Pub. Date: Mar. 27, 2008

(54) AUXILIARY POWER SUPPLY APPARATUS AND METHOD

(76) Inventors: Ashur Kanon, Rancho Cordova, CA (US); Felix Wong, Rancho Cordova, CA (US)

Correspondence Address: Brian R. McGinley;Sonnenschein Nath & Rosenthal LLP, Wacker Drive Station, Sears Tower, P.O. Box #061080, Chicago, IL, 60606-1080, US

(21) Appl. No.: 11/852,719

(22) Filed: Sep. 10, 2007

Related U.S. Application Data
(60) Provisional application No. 60/824,968, filed on Sep. 8, 2006.

(51) Int. Cl. H02J 9/00

(52) U.S. Cl. 187/290

(57) ABSTRACT

An auxiliary power supply apparatus and method thereof including a backup battery system having a power supply and a control board to provide an auxiliary power to an elevator control system upon failure of a primary power so that an elevator car may run to a next available upward or downward landing and open at least one door to the elevator.

### CROSS-REFERENCE TO RELATED APPLICATIONS

This application claims the priority of U.S. Provisional Patent Application No. 60/824,968, filed on Sep. 8, 2006, in the United States Patent & Trademark Office, the disclosure of which is incorporated herein by reference in its entirety.

### BACKGROUND OF THE INVENTION

1. Field of the Invention

The present general inventive concept relates generally to auxiliary power supply apparatus and methods of motion control systems such as backup battery systems comprising a power supply and a control board, and more particularly, to an auxiliary power supply system capable of supplying a secondary power to an elevator control system upon failure of a primary power so that an elevator may run to a next available landing and open a door to the elevator.

2. Description of Related Art

In the elevator industry, there is a potential that if a power supply fails, then an elevator car may become trapped in the elevator between floors. There are different types of elevators but conventional elevator systems use a main power supply to operate an elevator system which includes controls, at least one elevator car, at least one elevator door to the elevator car, and a computer system. If the primary power system fails, it is likely that any passengers and/or freight that are being transported within the elevator car will be stuck in between floors since the main power supply of convention elevator systems, in the event of a power failure, does not provide sufficient power to allow the elevator car to proceed to the next floor and open the elevator door for the passenger to exit the elevator car or for freight to be removed. This can be a frightening and dangerous situation for a trapped passenger or can delay business activity if freight is trapped, which is aggravated if power is unable to be quickly restored.

To deal with such entrapments caused by common power loss, the elevator industry has implemented various emergency systems including emergency phone systems to enable a trapped passenger to call a service mechanic or emergency personnel if the elevator is stuck. Another emergency system includes overhead door escape hatches to allow for removal of passengers if necessary. However, these emergency systems do not prevent entrapment in the elevator car for at least a period of time. Entrapment becomes exceptionally dangerous if there is a fire. In the case of a fire, time is essential for evacuating passengers quickly and safely.

There are elevator systems in the industry that, in an emergency, will move the elevator car or allow the elevator car to be moved to the next lower floor. A back-up power supply system is used to very slowly move the elevator car to the next lower floor, or gravity is used to allow the elevator car to move down to the next floor. When the elevator car arrives at the next lower floor the elevator car doors will then open using the back-up power supply system, or the doors may be pried open.

Conventional back-up power supplies are only capable of lowering the elevator and do not have enough power to move the elevator car to an upper floor. Further, even if the conventional back-up power supplies had enough power to move the elevator car to an upper floor, conventional elevator control systems do not have any embedded logic required to assist the control system in determining which direction the load was moving without the use of standard load weighing devices. Still further, conventional back-up power supply systems use a battery to operate when the primary source of power is lost and the power supply from the battery can be limited, especially if there is more than one elevator car. If the back-up battery system fails, then passengers or freight will be trapped.

Another problem with conventional battery back-up systems is that the battery will lose power overtime and may not have enough power to move the elevator car to a floor and open the door to allow the passengers to get off of the elevator car safely. As such, the battery must be routinely checked to ensure sufficient battery power and replaced in the event there is insufficient power. Since batteries may discharge at different rates depending on factors including heat, age, and usage, determining the frequency of battery checks is mere guess work.

### SUMMARY OF THE INVENTION

The present general inventive concept provides a power supply system and an auxiliary system control board. In the event of a power failure or disruption, the auxiliary system will send a signal to an elevator control board informing the elevator control board that the elevator is operating in emergency power status, which activates an auxiliary power supply system. The auxiliary system control board determines an elevator load direction and communicates the direction to the elevator control board, which operates the elevator at a reduced power level, directs the elevator car to the nearest floor, whether it is up or down, and opens the doors of the elevator car.

Additional aspects and advantages of the present general inventive concept will be set forth in the description which follows and, in part, will be obvious from the description, or may be learned by practice of the general inventive concept.

### BRIEF DESCRIPTION OF THE DRAWINGS

These and or other aspects and advantages of the present general inventive concept will become apparent and more readily appreciated from the following description of the embodiments, taken in conjunction with the accompanying drawings of which:

FIG. 1 is a diagram illustrating the functionality of an exemplary embodiment of the present general inventive concept.

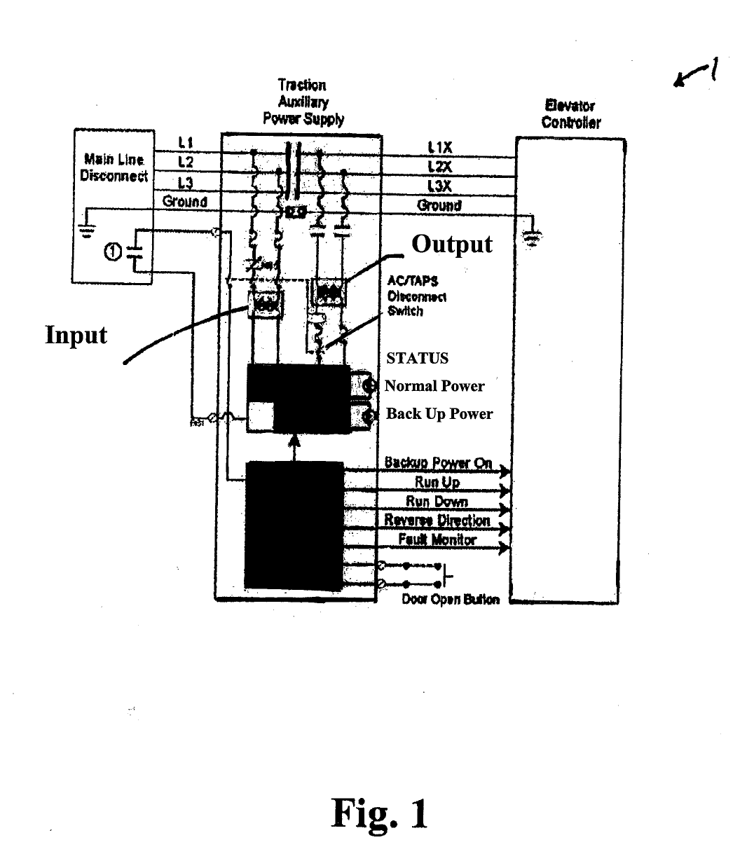

### DETAILED DESCRIPTION OF THE PREFERRED EMBODIMENTS

A detailed embodiment of the present general inventive concept is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present general inventive concept in virtually any appropriately detailed structure.

Reference will now be made in detail to the embodiments of the present general inventive concept, examples of which are illustrated in the accompanying drawings. The embodiments are described below in order to explain the present general inventive concept by referring to the FIGURES.

The present general inventive concept is directed to an auxiliary power supply system or auxiliary system 1 including a power supply and an auxiliary system control board. When there is a loss or disruption of primary power, the auxiliary system 1 will supply a single phase AC power to both the AC drive and to the elevator controller. At the same time, the control board of the auxiliary system 1 will provide a signal to the elevator control system informing it that it is being powered by the auxiliary system 1 instead of by primary power. The auxiliary system control board will calculate and provide a load directional signal to the elevator control system. The elevator control system will then run the elevator at a very low speed, in a preferred embodiment around 3 Hz, to the next available landing. The auxiliary system 1 will provide the door operator power to open one or more elevator car doors.

To ensure that the auxiliary system 1 has adequate power to complete any necessary operations, the auxiliary system 1 constantly monitors its output current from the power supply via serial communication. During normal operation of the elevator system under primary power, the auxiliary system 1 builds or recharges to maintain reserve energy while continuously monitoring primary power.

The auxiliary system 1 continuously monitors the power supply even during normal operation of the elevator system. If commercial power is lost, the power supply controller signals the elevator control that it is operating under emergency power and calculates and provides a load direction signal to determine the direction in which the elevator car was going in order to allow the elevator car to continue along its original direction. If the output current rises above a preset value (e.g., around 80% of the power supply rated output current), the auxiliary system 1 will assume the direction of travel is against the direction of the load. The auxiliary system 1 will then send a signal to the elevator control system commanding it to stop and reverse the direction of travel. The auxiliary system control board will use the least amount of energy necessary to reach the closest floor.

In the situation when the intended direction of travel of the elevator car is downward, the auxiliary system 1 also enables the elevator control system to utilize gravity to reduce the overall power consumption from the battery, thus conserving power and/or allowing more power to run other pieces of the system as the elevator is controllably lowered using gravity.

The auxiliary system 1 will also monitor the status of the power supply. If the auxiliary system 1 detects a problem with the power supply, the auxiliary system control board will send a signal to the elevator control system. The elevator control system can then notify a service mechanic if the notification option is available on the elevator control system side.

The auxiliary system 1 also monitors the batteries of the power supply and if the batteries need to be serviced, a signal will automatically be sent to the elevator control system. The automation of the signals for servicing is an important feature that ensures that the auxiliary system 1 is available and working properly at all times.

The auxiliary system 1 also allows bypass of the controller when it is necessary to shut down the elevator controller and backup power is not desired. The bypass allows complete shut-off of power and is an important safety feature to prevent injury during servicing of the elevator by the service mechanic.

In another embodiment, the auxiliary power supply system maintains user adjustable and programmable control parameters.

The general inventive concept described above can be embodied as computer-readable codes on a computer-readable recording medium. The computer is any device having a data processing function. The computer-readable recording medium is any data device having a data processing function. The computer-readable recording medium is any data storage device that can store data which can be thereafter read by a computer system. Examples of computer-readable recording mediums include read-only memory (ROM), random-access memory (RAM), CD-ROMs, magnetic tapes, floppy disks, and optical data storage devices.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An auxiliary power supply system comprising:
an auxiliary power supply;
a motion detector to detect a motion of an elevator car powered via a primary power supply; and
a control board to activate the auxiliary power supply if the primary power supply fails or is disrupted;
wherein the control board controls movement of an elevator car based on a signal from the motion detector if the primary supply fails or is disrupted.

2. The auxiliary power supply system of claim 1, further comprising:
a signal generated by the auxiliary power system and transmitted to the control board if the primary power supply fails or is disrupted and the auxiliary power supply is activated.

3. The auxiliary power supply system of claim 1, further comprising:
an auxiliary power supply safety shut-off switch to enable complete power shut-off to the elevator car during maintenance thereof.

4. The auxiliary power supply system of claim 1, further comprising:
an auxiliary supply by-pass switch to enable a user to by-pass the auxiliary power supply system.

5. A method of controlling an elevator system, the method comprising:
providing a first power source as a primary power supply;
providing a second power source as a second power supply;
powering an elevator car via the second power source if the first power source fails or is disrupted;
determining motion via a motion detector;
outputting a signal via the motion detector;
moving the elevator car to a predetermined location based on the signal and via the second power source if the first power source fails or is disrupted; and
opening one or more elevator car doors via the second power source when the elevator car reaches the predetermined location if the first power source fails or is disrupted.

6. The method of claim 5, further comprising:
transferring power to the elevator car from the first power source to the second power source without interruption of power if the first power source fails or is disrupted.

7. The method of claim 5, further comprising:
determining whether an actual charge of the battery is sufficient to move the elevator car to the predetermined location and open the one or more doors.

8. The method of claim 5, further comprising:
calculating a minimum power amount to move the elevator car to the predetermined location and open the one or more doors; and
outputting the minimum power amount.

9. The method of claim 5, wherein the predetermined location is an optimal floor in an upward direction or downward direction.

10. The method of claim 9, wherein the optimal floor is based on proximity to the predetermined location, proximity to the nearest floor, type of load, or priority of load delivery.

11. The method of claim 5, wherein the predetermined location is a nearest floor in a same direction that the elevator car was moving when failure or disruption of the first power source occurred.

12. The method of claim 5, wherein the predetermined location is an original destination that the elevator car was moving to when failure or disruption of the first power source occurred.

13. The method of claim 5, further comprising:
continuously monitoring the second power supply during use of the first power supply to ensure the second power supply contains a predetermined amount of power.

14. The method of claim 5, wherein the first power supply is AC power and the second power supply is DC power.

15. The method of claim 5, further comprising:
monitoring a charge of the second power supply; and
charging the second power supply if the charge is below a predetermined charge level.

16. The method of claim 15, wherein the charging of the second power supply is automatically executed.

17. The method of claim 5, wherein the predetermined charge level is calculated based on elevator car quantity, elevator car capacity, elevator shaft size, or distance between floors.

18. Apparatus for controlling movement of an elevator car in the event of a power loss or disruption, comprising:
a power supply;
a motion detector; and
a control device to move the elevator car to the next nearest floor in the event of the power loss or disruption.
